(19) United States
(12) Patent Application Publication
(10) Pub. No.: US 2024/0239667 A1
(43) Pub. Date: Jul. 18, 2024

(54) METHOD FOR PRODUCING MESOPOROUS TRANSITION-METAL CARBIDE LAYERS WITH DEFINED NANOSTRUCTURING, AND USE OF SAID TRANSITION-METAL CARBIDE LAYERS IN ELECTROCATALYSIS

(71) Applicant: TECHNISCHE UNIVERSITÄT BERLIN, Berlin (DE)

(72) Inventors: Marvin FRISCH, Berlin (DE); Ralph KRÄHNERT, Berlin (DE)

(73) Assignee: TECHNISCHE UNIVERSITÄT BERLIN, Berlin (DE)

(21) Appl. No.: 18/562,076

(22) PCT Filed: May 9, 2022
(86) PCT No.: PCT/EP2022/062407

§ 371 Date: Nov. 17, 2023

(30) Foreign Application Priority Data
May 18, 2021 (EP) 21174253.1

(51) Int. Cl. C01B 32/949; C01G 41/02

(52) U.S. Cl. CPC C01B 32/949; C01G 41/02; C01P 2002/72; C01P 2004/03; C01P 2004/84; C01P 2006/17

(57) ABSTRACT

The invention relates to a method for producing mesoporous metal carbide layer with defined nano-structuring, wherein during a first method step a mesoporous metal oxide layer is made available and in a second step, the metal oxide layer is brought in contact in a reducing atmosphere with a carbon source in the atmosphere, wherein the temperature is at least 650° C. and the heat-up rate ranges from 0.5 to 2 kelvin per minute.

### CROSS-REFERENCE TO RELATED APPLICATIONS

This application is a United States National Stage Application of International Application No. PCT/EP2022/062407 filed May 9, 2022, claiming priority from European Patent Application No. 21174253.1 filed May 18, 2021.

### FIELD OF THE INVENTION

The invention relates to a method for producing mesoporous metal carbide layers with defined nano structuring.

### BACKGROUND OF THE INVENTION

Various transition metal carbides are described in the prior art which are distinguished by their extremely high mechanical and thermal stability as well as their metal electric conductivity. Owing to these advantageous characteristics, the transition metal carbides are used, among other things, as heat-resistant materials, as wear-resistant cutting materials, as well as in the field of heterogeneous catalysis or electro-catalysis and for aircraft manufacturing.

Materials with a high specific surface area are required for many of these uses, for example in the electro-catalysis. Transition metal carbides such as tungsten (wolfram) represent promising alternatives to platinum-based electro catalysts for the electrochemical hydrogen production. The WO 2013/137827, for example, discloses mesoporous nanorods of tungsten carbide, which can be produced starting with tungsten (VI)-oxide-nanorods. The tungsten carbide nanorods in powder form function as support material for platinum nano particles. Owing to the high electrical conductivity and specific surface area of the support material, higher catalytic activities and stabilities are achieved in the hydrogen-forming reaction. Furthermore disclosed is that metal carbides with high specific surface areas and high electrical conductivity are advantageous for electro-catalytic applications.

Besides the uses for the catalysis, these compounds are becoming increasingly important in the field of material mechanics (e.g. as porous grinding tools). As a result of the highly porous structures, damage to the material can be minimized since the thermal stress on the materials is lower than for comparable materials.

With respect to the production of homogeneous mesoporous metal oxide layers, the prior art discloses that the use of a chemical complex with the addition of a complex-forming ligand in place of a molecular, respectively ionic, metal precursor compound has proven to be especially suitable. The DE 10 2012212237 discloses that mesoporous templated metal oxide layers as well as metal carbonate layers can be produced by adding a micelle-forming structure template. Furthermore disclosed is that metal oxides can be produced with the aid of stabilizing ligands, wherein the production of mesoporous templated metal carbides is not described. Also not disclosed in the prior art is that a porous nano-structuring of the carbides via templating is possible. Furthermore not described is the production of thin layers of substrates and their pseudomorph transformation from oxide to carbide.

The WO 2013/137827 discloses a process for the synthesis of tungsten-carbine nanorods. For this, the tungsten-oxide (WO₃) nanorods in powder form are mixed with an organic carbon source to obtain a precursor which (the precursor) is subsequently treated thermally (carbonized) in a reducing atmosphere. Tungsten-carbide nanorods form at high temperatures of preferably 900° C. in the form of a mesoporous powdery material. The carbon source preferably comprises glucose and the term mixing in particular refers to forming a mixture of tungsten oxide (WO₃) nanorods with the glucose, wherein the method furthermore comprises the hydro-thermal treatment of the mixture and the evaporation of the hydro-thermally treated mixture prior to the carbonizing.

Liaoyuan Xia et al., in “An easy soft-template route to synthesis of wormhole-like mesoporous tungsten carbide/carbon composites.” Composites science and technology 71: 1651-1655 (2012) discloses a method for the production of (worm-hole type) mesoporous tungsten carbide/carbon (WC/C) compound materials. Based on the teaching of Xia et al. (2012), three steps in particular are required to produce the WC/C compound materials. A solution is first produced of PFM resin precursor (phenol formaldehyde melamine) and the tenside triblock-copolymer F127 in ethanol/water as solvent mixture. Subsequently, a certain amount of watery ATOH solution (English: ammonium tungsten oxide hydrate) is dispersed in the aforementioned solution to form a W/O emulsion through vigorous stirring and stabilizing of F127. Finally, the triblock copolymer template is removed through calcination and tungsten carbide is produced in situ through carbo-thermal reduction, so as to obtain the (worm-hole type) mesoporous WC/C compound material. The carbon, which in this case serves as matrix for the compound material functions to ensure the structural cohesion of the composite and/or compound material. The source for the carbon is the PFM resin precursor. The method according to Xia et al. (2012) has disadvantages with respect to the homogeneity of the produced structures. It is a compound material where the metal carbide particles, measuring approximately 40 nanometers, are surrounded by large amounts of carbon, resulting in disadvantages for further applications, for example in the electro-catalysis.

A-Ra Ko et al. in “Ordered mesoporous tungsten carbide nanoplates as non-Pt catalysts for oxygen reduction reaction.” Applied Catalysis A: General 477: 102-108 (2014) discloses a method for producing mesoporous tungsten carbide catalysts. Starting with previously produced layered tungsten nitride nano particles, pore structures of small tungsten carbide nano plates are made available for this in dependence on the reaction temperature that is used. In order to produce powder-form nano particles of layered tungsten nitride, layered tungsten oxide is produced in a hydrothermal process. Following the hydrothermal process, the resulting precipitate is cooled down to room temperature, is washed several times with ethanol and distilled water, and is subsequently filtered. Tungsten oxide is obtained in the form of a powder following a drying process. The resulting powder is then dispersed in a solvent and brought in contact with a precious metal (e.g. palladium, Pd).

Concerning the known prior art methods, there is potential for improvement. In particular, there are disadvantages to using the pore structures that form in an electrolyzer setup. For example, the known methods do not result in sufficiently homogeneous pore structures, especially for the coatings with an adjustable, similar layer thickness, orthogonal to the coated substrate. A lack of availability of catalytically active species therefore exists, which is a disadvantage for an efficient realizing of the intended reactions. The prior art therefore strives to offer alternative and, in particular, improved methods for the production of mesoporous (metal carbide) layers.

### SUMMARY OF THE INVENTION

The disadvantages of the prior art were corrected with the help of the inventive teaching. The teaching of the invention is characterized by the independent patent claims. In one aspect, the teaching relates to a method for producing mesoporous metal carbide layers with a defined nano structuring, comprising the following steps:
a) Making available a mesoporous metal oxide layer;
b) Bringing this metal oxide layer in contact with a reducing atmosphere at a temperature of at least 650° C., which results in the forming of a mesoporous metal carbide layer through carburizing (cementation) reaction with a heating-up rate of 0.5 to 2 kelvin per minute, wherein this metal carbide layer has a defined nano structuring as a result of the aforementioned method steps, wherein preferably a carbon source is present in the atmosphere, in particular methane or ethylene.

The minimum temperature, in particular for a complete carburizing reaction, is approximately 650° C. In light of this disclosure, an expert knows that somewhat lower temperatures such as approximately 645° or also approximately 600° C. can be used for less complete or incomplete carburizing reactions. For preferred transition metals, such as tungsten and molybdenum, the useful temperature range for the carburizing reaction is in the range of approximately 650° C. to approximately 800° C. The average expert can determine the respectively optimum temperatures for other transition metals through simple routine experiments.

The present invention thus relates in one aspect to a production method for porous transition metal carbide layers with a defined nano structuring and homogeneous pore structure, starting in particular from mesoporous transition metal oxide layers by using a carburizing reaction at temperatures of in particular at least 650° C., wherein the heat-up rate ranges from 0.5 to 2 kelvin per minute.

According to the IUPAC convention, porous materials can be divided into microporous (<2 nm), mesoporous (2-50 nm) and macro-porous (>50 nm) materials, depending on their medium pore size (diameter). In connection with the invention, we are dealing in particular with the production of mesoporous materials. Within the meaning of the invention, the terms nano structure or nano structuring are essentially used synonymous. The average expert uses these terms for the occurrence of (at times periodic) characteristics on the size scale of one to several hundred nanometer. In general, a nano structure shows in at least one dimension a size in the nano range of 10⁻⁹ m. Within the meaning of the invention, the pore values of the materials for the average diameter are in the range of mesopores (according to IUPAC). In this sense, the inventive materials are nano structured materials. The pore structure within the meaning of the invention describes the occurrence of pores with similar diameter and a similar pore shape. Within the meaning of the invention, spherical pores in particular are present—which are present contracted with the axis perpendicular to the substrate—thus advantageously resulting in an elliptical pore form. The contraction in the axis perpendicular to the substrate is the result of a thermal treatment and the simultaneous removal of the template.

Within the meaning of the invention, the term carburizing, respectively carburizing reaction, describes the conversion of an oxide into a carbide under reducing conditions. Carbon-containing gas or an analogous gas functions as “carburizing agent” and drives the reaction in the direction of forming a carbide. In preferred embodiments, the “carburizing agent” can also be referred to as carbon source.

The carbon source, for example methane, is preferably introduced from the outside and comes in contact with the mesoporous metal oxide layer. The carbon source preferably is in the form of a gas and is thus present as a gas. With the aid of a gas-type carbon source, it was especially easy to actively control the reaction, which was surprising and could be achieved by the inventors through systematic research of the influence of the individual parameters during the production route.

In another aspect, the invention therefore is based on the fact that the production method for mesoporous metal carbide layers permits a targeted adjustment of the phase composition, the crystallinity and the layer thickness.

The term phase composition describes the stoichiometry of the produced metal carbide layer. The layer can contain very different non-stoichiometric metal carbide compositions, e.g. a mixture of the phases WC and W2C at a ratio of approximately 1:1. In addition, following exposure of the materials to air after the production, a thin (several nm) surface oxide layer forms, which influences the total composition of the material.

The crystallinity of the materials can be changed in dependence on the parameters selected for the carburizing reaction. For example, the mean crystallite size in the metal carbide layer can be influenced by the temperature of the carburizing reaction. With the materials at hand, nano-crystalline carbides (starting from nano crystalline oxides) are advantageously formed. The crystallites are preferably oriented relative to each other and come in sizes of several nanometers.

The layer thickness in connection with the invention explicitly refers to the mean diameter of the layer, essentially perpendicular to the substrate. The substrate is typically not included in the representation of the layer thickness. The layer thicknesses, for example, influence the catalytic activity and can be varied through adapting the concentration of the precursor compounds in the reaction solution during the oxide synthesis. In addition, the layer thickness can be adjusted through changing the draw speed during the immersion coating (dip coating) and is furthermore dependent on the substrate used.

It was a complete surprise that a homogeneous nano structuring could be produced with the production method according to the invention, which mostly remained intact during the carburizing reaction, in particular in a reducing, methane-containing gas mixture. This can advantageously be achieved especially well if the nano structuring is achieved with mesoporous templated metal oxide layers, produced through immersion coating.

The required high temperatures for the metal carbide formation usually make it more difficult to obtain or form a porous structuring because of significant crystal growth and sinter effects. The method according to the invention therefore represents an important advance in the production of nano structured transition metal carbide layers with metal layer conductivity. The teaching according to the invention consequently discloses a method for producing (mesoporous) mono- as well as bimetal transition carbide layers with defined nano structuring, starting from the previously produced mesoporous templated mono-metal or bimetal transition metal oxide layers.

The transition metal oxides as well as the associated metal carbides are advantageously present in poly-crystalline, respectively nano-crystalline form. Depending on the temperature of the carburizing reaction, different carbide phases are formed. In addition to the mono-metal or bimetal transition metal oxide layers, the invention also comprises the production of multi-metal layers with three or more metals. Within the meaning of the invention, the terms mono-metal, bimetal, or multi-metal layers refer to the production of carbide layers which can contain phase shares of different transition metal carbides, thus for example mixtures of W—V—Cₓ. Preferably these are not non-physical, homogeneously distributed shares of two or several metal carbide phases which form the wall material of the mesoporous layer. The designations of bimetal or multi-metal layers, for example, is independent of the substrate used.

It was completely surprising that low temperatures of, for example, 650° C. or 700° C. over a period of 30 minutes to 10 hours, preferably 4 to 8 and especially preferred 6 hours are sufficient to achieve a volume phase conversion from the oxide to the associated carbide.

Especially preferred temperature ranges for porous tungsten carbide layers are between 700 and 750° C. For molybdenum carbide layers, temperatures of 700° C. are preferred for a complete phase conversion. It was particularly surprising that the low heat-up rate of 0.5 to 2 kelvin per minute, preferably 0.75 to 1.5 kelvin per minute, in particular 1 kelvin per minute, is decisive to obtain the desired pore structure.

The pore structure is advantageously distinguished by an especially pronounced homogeneity. The homogeneity of the pore structure preferably refers to the fact that the pores of the structure are distinguished by an essentially uniform structure, especially concerning the pore size and/or distribution.

Surprisingly, the formed mesoporous metal carbide layer also exhibited excellent homogeneity. The homogeneity of the metal carbide layer refers to the homogeneity of the pore structure, the layer thickness, the phase composition and/or the crystallinity. The homogeneity of the metal carbide layer relates to achieving an essentially uniform value or value range for one or several of the aforementioned characteristics. The average pore diameter as well as the average pore spacing, the average wall thickness and the characterization of the pore shape in this context can be estimated from grid (REM) and transmission (TEM) electron microscope recordings. The evaluation of the representative REM recordings indicates a spherical shape of the pores in the plane, parallel to the substrate positioned underneath which appears to be elliptical, as seen in orthogonal direction to the coated substrate, owing to contraction forces during the thermal treatment. The analysis of the REM recordings with the aid of the so-called Fourier transformation technology (FFT), using an image processing program that is known to one skilled in the art, provides the shape of a spherical ring which points a certain degree of local pore arrangement in the plane, parallel to the substrate which, in turn, is understood as effect of the templating. An evaluation of the average pore diameter using several REM recordings provides small pore size distributions (approaching Gauss distribution). As compared to the prior art, the preferred method allows achieving a clear improvement in the homogeneity.

Terms such as essentially, approximately, and the like preferably describe a tolerance range of less than ±40%, advantageously less than ±20%, especially preferred less than ±10%, even more preferred less than ±5%, and in particular less than ±1% and always comprise the exact value. ‘Similar’ describes preferably sizes that are approximately the same. ‘Partially’ preferably describes to at least 5%, especially preferred to at least 10% and even more preferred to at least 20% and, in some cases, to at least 40%.

A different embodiment of the invention provides that making available the mesoporous metal oxide layer comprises the following steps:
i) Providing a metal precursor, a template, a first solvent and a complex former, wherein the complex former contains a carboxy group, wherein the metal precursor, the template and the complex former are dissolved in the first solvent, so that metal precursor complexes form;
ii) Coating of a substrate with the metal precursor complexes, so that a micelle-templated film layer (mesophase) forms on the substrate;
iii) Thermal treatment of the film layer under an inert gas atmosphere to form a templated, mesoporous metal oxide.

Within the meaning of the invention, a template preferably designates a substance used as place holder for a desired pore structure, so as to produce the pore structure of the metal oxide layer, in particular by using the template. During the inventive process, the template is preferably enclosed by the surrounding material, in particular the metal precursor, and leaves a porous structure (pore structure) once it is removed. The template is preferably removed during the thermal treatment. Depending on the template size, pore structures and pore sizes result which correspond in particular to the size of mesopores. Materials with an ordered pore structure and a monomodal pore size distribution can thus advantageously be synthesized via the so-called templating methods, wherein templates function advantageously as place holders for the desired pore forms.

A solvent preferably designates a substance that is used to dissolve another substance and dilute it in the process, without this (the dissolving process) resulting in a chemical reaction, meaning between the solvent and the material to be dissolved. The first solvent is thus preferably used to dissolve the metal precursor, the template, and the complex former.

The expression “micelle-templated film layer” preferably means that a film layer was obtained when using a micelle-forming template for forming the pores, in particular the pore structure. The term micelles denotes aggregated molecule complexes (aggregates), comprising amphiphile molecules (tensides). Depending on the solvent (mixture) used and the tenside concentration, the shape of the micelles can vary (e.g. spherical, rod-shaped, lamellar and the like) and can be formulated specifically. The film layer preferably is a layer with a micro and/or nano structure. In particular, the film layer is distinguished by a small layer thickness in the range of 30-2000 nm. The film layer is preferably a thin layer.

An inert gas atmosphere advantageously means that an atmosphere is present and/or is made available which contains at least one inert gas. The average expert therefore knows that an inert gas atmosphere means that at least one inert gas is provided. The thermal treatment of the film layer under an inert gas atmosphere therefore means in particular that at least one inert gas is present during the thermal treatment of the film layer, so that the film layer in particular is subjected to at least one inert gas during the thermal treatment.

A templated mesoporous metal oxide within the context of the invention preferably refers to a metal oxide having maintained its mesoporous structuring (thus in particular the mesopores) by using a template.

The preferred providing of the nano crystalline transition metal oxide layer with mesoporous templated structuring advantageously occurs in a defined ternary gas mixture, resulting in obtaining of the mesoporous structures in a corresponding carbide layer. The nano-crystalline oxide particles of the porous wall material surprisingly catalyze the conversion to the carbide, thus making low temperatures sufficient for the carburizing reaction to a preferred complete volume conversion. Surprisingly, very defined transition metal carbide layers with high pore arrangement as well as a specific surface area can be produced.

Within the meaning of the invention, a high pore arrangement in particular describes a regular pore arrangement. The term regular pore arrangement is known to the experts. The terms high pore arrangement and regular pore arrangement are used synonymous within the meaning of this invention. The regular arrangement of the pores results from the micelle templating during the synthesis of the layer. Following the thermal treatment, a replica of the precipitated out mesophase forms which is distinguished in that the median pore-to-pore distance is in the range of several nanometers and hardly varies. In this connection, a preferred median pore diameter is found in dependence on the template used. These characteristics describe the defined layers within the meaning of this invention. The high, respectively regular, pore arrangement can be found across several centimeters to (theoretically) also several meters in the plane parallel to the substrate. The specific surface area for the invention is defined in particular via the ratio of surface in m² to weight and/or material mass. A high specific surface area consequently implies the internal surface area of a material, not the outer one which is easy to see. The term pore arrangement is characterized in the DE 10 2012 212 237 A1 or in the WO 2011 048 149. This prior art also discloses which parameters have proven themselves with respect to the pore arrangement or the surfaces.

Another preferred embodiment of the invention provides that the contacting period for the metal oxide layer in the reduced atmosphere ranges from 30 min to 10 hours. Depending on the metal, this time period is sufficient to achieve a conversion from the provided transition metal oxide layers to the desired transition metal carbide layers. It was completely surprising that this time period is sufficient for executing the complete phase conversion at the preferred low temperatures.

A further preferred embodiment of the invention provides that the reduced atmosphere comprises a ternary gas mixture, preferably argon, hydrogen, ethane, ethylene, CO, CO/CO₂ and/or methane, wherein the ratio between methane and hydrogen preferably ranges from 5 to 7:1.

Especially preferred is a hydrogen and methane ratio of 6:1. Surprisingly, the preferred ternary gas mixture ensures the complete phase conversion to the carbide. However, it was completely surprising that this gas mixture results in an especially strong adherence of the oxide layers, but especially the carbide layers, for very different substrates. In particular the use of methane, respectively hydrogen, at the preferred ratio results in a surprisingly good yield of mesoporous transition metal carbide layers having a defined nano structuring.

Yet another preferred embodiment of the invention provides that the metal precursor comprises a metal and/or a transition metal, so that the metal oxide is a transition metal oxide and the metal carbide a transition metal carbide. Bimetal compounds such as V—W—Cₓ or Ni—W—Cₓ are also preferred.

According to a different preferred embodiment of the invention, the metal precursor is a metal and/or a transition metal, selected from the group consisting of scandium, titanium, vanadium, chromium, manganese, iron, cobalt, nickel, copper, zinc, yttrium, zirconium, niobium, molybdenum, technetium, ruthenium, rhodium, palladium, silver, lanthanum, cadmium, hafnium, tantalum, tungsten, rhenium, osmium, indium, platinum and/or gold.

It came as a complete surprise that the aforementioned metal precursors in particular are especially well suited to solve the inventive problem.

The term “precursor” is known from chemistry as a preliminary stage for a compound that participates in a chemical reaction or a chemical reaction sequence (a sequence of several reactions) which results in a different compound. Within the meaning of the invention, a metal precursor thus designates a metal or a transition metal that is used in preferred embodiments of the method and serves to provide the mesoporous metal carbide layer. In particular, the metal precursor functions to provide the metal for the metal oxide layer.

In the context of the invention, a transition metal comprises chemical elements with the atomic numbers 21 to 30, 39 to 48, 57 to 80 and 89 to 112. Since all of these elements are metals, the term “transition metal” is clear to the average expert.

According to a different preferred embodiment of the invention, the complex former or formers comprise mono-carbon, dicarbon, or tri-carbon acids, amino acids and/or ethylene diamine tetra acetic acid.

Within the meaning of the invention, complex formers are anions of acids since these can enter a coordination connection with the metal cations. A complex former preferably designates a chemical compound which can enter into complex connection with specific central atoms. In particular, a complex former comprises anions with free electron pairs which form coordinate connections with metal ions or metal atoms, especially with the metal ions or metal atoms of the metal precursor.

Porous oxide layers are known from the prior art (DE 10 2012 212 237 A1). Surprisingly, it has turned out that the preferred complex formers are particularly suitable for making available the mesoporous metal oxide layers.

Another preferred embodiment of the invention provides that the template forms micelle and/or lamellar structures and that the template is an amphiphile polymer, preferably an amphiphile block polymer.

The amphiphile block copolymer is advantageously selected from a group comprising polyethylene oxide-block polybutadiene-block-polyethylene oxide (PEO-PB-PEO), polyethylene oxide-block-polypropylene oxide-block-polyethylene oxide (PEO-PPO-PEO), polypropylene oxide-block-polyethylene oxide-block-polypropylene oxide (PPO-PEO-PPO), polyethylene oxide-block-poly isobutylene-block-polyethylene oxide (PEO-PIB-PEO), polyethylene-block-polyethylene oxide (PE-PEO), polyisobutylene-block-polyethylene oxide (PIB-PEO) and polyethylene-co-butylene)-block-poly (ethylene oxide) (PEB-PEO), polystyrene-block-poly(4-vinyl pyridine) (PS-P4VP) or mixtures thereof, preferably polyethylene oxide-block-polybutadiene-block-polyethylene oxide (PEO-PB-PEO).

It has turned out surprisingly that the aforementioned and preferred templates, in particular the block copolymers, are especially suited to solve the object according to the invention.

According to a different preferred embodiment of the invention, it is provided that the solvent used comprises C1-C4 alcohol, C₂-C₄ ester, C₂-C₄ ether, formamide, acetone nitrile, acetone, tetrahydrofuran, benzyl acetate, toluene, dimethyl sulfoxide, dichloromethane, chloroform, methanol, ethanol, water or mixtures thereof.

Surprisingly, it has turned out that the use of the preferred solvents results in particularly good porous oxide layers. Furthermore surprising was that adding small amounts of water to one of the preferred solvents, respectively solvent mixtures, results in an even better formation of mesoporous oxide layers.

It did not suggest itself to the average expert that the use of the aforementioned solvents together with the teaching according to the invention would lead to an especially efficient and good implementation of the production method for forming oxide layers or for forming the desired mesoporous carbide layers.

According to a further preferred embodiment of the invention, the substrate is coated with the aid of immersion coating, doctor-blading, drip-coating, casting coating, spin coating and/or spray coating.

The inventive coating step, which is realized in i) of the process by making available the mesoporous metal oxide layers, is realized especially preferred with the immersion coating method. However, the further mentioned coating methods are also preferred. Particularly good results are achieved with the especially preferred immersion coating methods if the pull-back speed is in the range of 1 to 500 mm per minute and/or if the temperature during the coating ranges from 10 to 50° C. and/or the drying time is in the range of 0.1 minute to 2 hours. It is especially preferred if the humidity is between 10 and 60%.

Another preferred embodiment of the invention provides that the metal oxide is formed at a temperature between 350 and 650° C. in the reduced gas mixture. The metal oxide is advantageously produced with a method comprising the aforementioned steps i), ii) and iii).

The thermal treatment of the film layer under an inert gas atmosphere to form a templated, mesoporous metal oxide (step iii) can occur at relatively low temperatures between 350 and 650° C. It came as a surprise that this temperature range for the thermal treatment of the film layer results in a mesoporous metal oxide layer which can subsequently be converted especially easily to a mesoporous metal carbide layer with the aid of the method according to the invention.

For another preferred embodiment of the invention, the substrate which can be coated is selected from the group consisting of silicon, silicon dioxide, silicon carbide, boron carbide, steel, graphite, graphene, glass carbon, gold, silver, platinum, copper, nickel, aluminum, titanium and/or alloys thereof and/or temperature-stable polymers, plastics and/or membranes, wherein the substrate preferably is a wafer. Within the meaning of the invention, expanded metals or metal foams can also be coated.

In a particularly important and central aspect, the invention relates to a metal carbide layer produced with the inventive method. The metal carbide layer is distinguished by a high pore order. The metal carbide layers within the meaning of the invention are macroscopically free of cracks as well as homogeneous and have excellent mono-metal or bimetal characteristics. The metal carbide layers have extraordinarily good and surprising physical characteristics, for example the defined pore structure in connection with their high electrical conductivity and mechanical stability (hardness).

Summed up, the transition metal carbide layers within the meaning of the invention have a plurality of advantageous characteristics which cannot be found in this combination in the prior art. Even if the production of numerous transition metal carbides is sufficiently disclosed, preferably in the form of poly-crystalline powder, the extremely high thermodynamic stability of the inventive transition metal carbide layers is a particular advantage. Many transition metal carbides according to the prior art additionally have only insufficient nano structuring of the pores.

It was completely surprising that according to the inventive teaching, permits especially the production of the metal carbide layer with defined structure, which allows forming defined layers without macroscopic cracks that vary little in their characteristics. For example, the mean pore diameter varies by less than 20%. In addition, a three-dimensionally linked pore system forms for all layers. This is decisive for the use in the catalysis and other preferred uses. The layer thickness can be adjusted precisely and hardly varies over several centimeters on the chosen substrate.

The metal carbide according to a different preferred embodiment is characterized in that the metal carbide layer has pores, wherein these pores can be mesoporous and/or macro-porous and wherein the pores are preferably homogeneously distributed.

It is particularly advantageous that the inventive metal carbide layers have mesopores ranging especially from 2 to 50 nm. Depending on the variation of the polymer template during the synthesis, macropores can also be produced. It was completely surprising that the mean diameter of the pores could be easily adjusted through variation of the polymer template. The mean distance from one pore to an adjacent pore can be adjusted easily by adapting the molar ratio of template to metal precursors, which respectively changes the wall thickness of the metal oxide or the metal carbide. The pores are preferably distributed homogeneously.

According to yet another preferred embodiment, the metal carbide is characterized in that the metal carbide layer is coated with another pore-conformal layer, in particular NiO.

A pore-conformal layer within the meaning of the invention preferably designates a continuous layer that covers the complete inner and outer accessible pore wall surface with a layer with adjustable layer thickness as well as a homogeneous material composition. The mean layer thickness of this uniform surface layer preferably ranges from a few to several nanometers. The total pore system, which is preferably structured three-dimensionally, is surface modified with a suitable method. The layer, which is advantageously precipitated out, consequently reduces the mean pore diameter in the resulting surface-modified substrate material, wherein the reduction of the pore diameter is preferably in the range of a few nanometers up to Angstrom. The term “conformal” in particular refers to maintaining the geometric structure of the surface of the porous substrate material. In this context, the pore shape, for example, remains essentially unchanged.

According to a further aspect of the invention, the metal carbide layers, which are obtained with the inventive method, are used as catalysts or catalyst carriers, as compound semiconductors in the photovoltaic field, the electrocatalysis or the photo(electro)catalysis, for the medical technology, as energy store, as magnetic data store, as polishing and buffing materials for the material processing and/or as carrier material for abrasives and/or lubricants.

The invention furthermore relates to a metal carbide produced with a preferred method, characterized in that the metal carbide layer is coated with an additional pore-conformal layer, in particular NiO, and the metal carbide layer is subsequently used as catalysts or catalyst substrate, as compound semiconductor in the photovoltaic field, the electrocatalysis or the photo(electro)catalysis, in the medical technology, as energy store, as magnetic data store, as polishing and buffing material for the material processing or as carrier material for abrasives and/or lubricants.

The preferred metal carbide layer is particularly suited for use as an electrode in the water electrolysis, particularly after the coating with the pore-conformal layer (especially when using an atomic layer precipitation), wherein the preferred coating of the pore-conformal layer represents a surface modification.

The average expert recognizes that technical features, definitions and advantages of preferred embodiments, which apply to the preferred methods of producing a mesoporous metal carbide layer, are equally true for the metal carbide layer produced according to the invention, as well as the preferred uses.

### BRIEF DESCRIPTION OF THE DRAWINGS

The invention is explained further in the following with the aid of figures, without being limited to these figures or the examples illustrated therewith.

FIG. 1 shows a diagram of the production route for the synthesis of mesoporous transition metal oxide and/or carbide layers, using the example of tungsten oxide, respectively carbide.

FIGS. 2 to 4 show scanning electron microscope images of the produced tungsten oxide or carbide layers in a view from above, enlarged 100,000 times, on a silicon wafer as substrate.

FIG. 5 shows the results of the X-ray diffractometric analysis of the mesoporous tungsten oxide or tungsten carbide layers measured under grazing light incidence (GI XRD) with monochromatic Cu-Ko-radiation having a wavelength of 1.54 Å on silicon substrates.

FIG. 6 shows the results of an electro-catalytic test measurement (alkaline oxygen-forming reaction, OER) compared to a reference system, prior to and after the precipitation of catalytically active species.

### DETAILED DESCRIPTION OF THE INVENTION

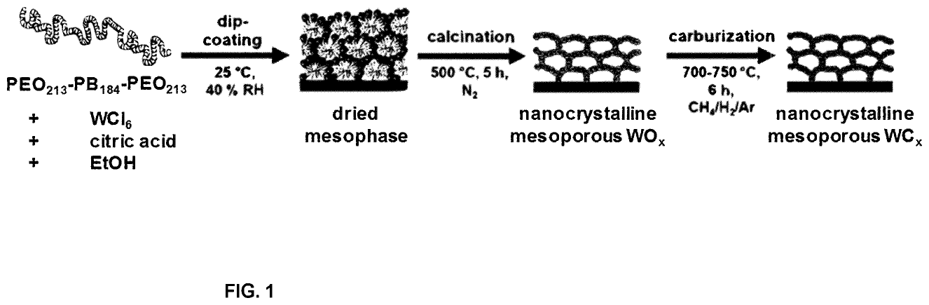

The FIGS. 1 to 6 show the production of macroscopic, crack-free, homogeneous mono-metallic or bimetallic transition metal carbide layers with defined pore structure on suitable substrates.

Metal carbide layers are distinguished by their excellent physical characteristics, for example a high electrical conductivity as well as mechanical stability (hardness) and are superior to the metal oxide layers. The production of numerous types of transition metal carbides, preferably in the form of poly-crystalline powder, is disclosed sufficiently. The high thermodynamic stability of the metal oxide phases requires for most metals very high temperatures for the phase conversion to carbide, which results in an irreversible loss of the porous nano-structuring of the materials. Through a suitable selection of the synthesis conditions, however, it is now possible to produce porous, nano-structured, macroscopically crack-free transition metal carbide layers by way of a carburizing reaction from the associated, mesoporous oxide.

By adding suitable transition metal precursors to the synthesis solution, bimetal oxides or carbides can additionally be produced. A special method was established for producing mesoporous templated transition metal oxides. This method is distinguished by the addition of a stabilizing, carbon-containing, anionic ligand, for example citrate, to the mono-metal or bimetal precursor solution in a suitable solvent, preferably ethanol. The solutions are distinguished by sufficient stability and resistiveness to hydrolysis and precipitation reactions and permit the production of homogeneous, macroscopically crack-free, porous films with defined structure through a following immersion coating process with subsequent thermal treatment under inert conditions. In the process, the pore-forming template used disintegrates almost completely through oxidation, which is additionally catalyzed through the adjacent Lewis acid metal cations.

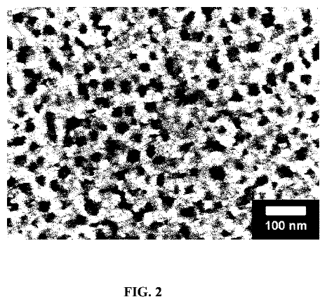

FIG. 2 shows that mesoporous templated structures can be generated in this way. Remarkably, the mechanical, respectively morphological, stability of these mono-metal or bimetal transition metal oxide films is sufficiently high to form a transition metal carbide layer in a subsequent carburizing reaction under reductive conditions, without causing irreversible loss of the pore structure, respectively the pore order, or without the occurrence of macroscopic cracks.

Owing to the oxidation sensitivity of the produced carbide materials, a thin oxide layer is generated on the surface of the carbides through a final passivation step, which prevents a complete oxidation. Following the carburizing reaction and the associated forming of the carbide phases in the volume, the mesoporous films exhibit metallic layer conductivity (measured with impedance spectroscopy at 25° C. in air). This significant increase in the electrical conductivity as compared to the oxide pre-stages is a further indication of the successful formation of a volume carbide phase.

Owing to these excellent electrical characteristics, the produced transition metal carbide layers are suitable for use, for example as substrates in the field of electro-catalysis. In this invention report, the use of templated porous tungsten carbide films as carrier materials for catalytically active species for the electrochemical water splitting is introduced for the first time. As conceptual proof, atomic layer deposition (ALD) was used to deposit NiO on the inner as well as the outer surfaces of the oxide and the carbide films and was examined in a rotating disc electrode in alkaline electrolyte. As compared to pure mesoporous NiOₓ films, a clear performance advantage could be achieved. Above all, this advantage could be traced back to the significantly higher electrical conductivity of the substrate material since NiO has semiconducting characteristics. Remarkably, the NiO coated tungsten carbide did not exhibit a noticeable reduction in the catalytic activity over 150 cyclo-voltammograms in 0.1 M KOH [potassium hydroxide] as electrolytes. With a comparable load of catalytically active NiO, clearly higher current densities could be reached as compared to the NiO coated WOₓ. The experiments show the principal usability of porous transition metal carbides as electrically conductive substrate materials for the electro-catalysis.

The drawings show in detail:

FIG. 1: Representation of the synthesis diagram for producing mesoporous templated transition metal oxide layers or transition metal carbide layers with the example of tungsten oxide and/or tungsten carbide layers. For this example, the addition of citrate is shown as stabilizing ligand for the metal precursor compound. The temperature of the carburizing reaction in the final step is preferably between 700 and 750° C.

FIG. 2: Image recorded with the scanning electron microscope (view from above) of a produced mesoporous templated Wₓ film on a silicon wafer for the substrate.

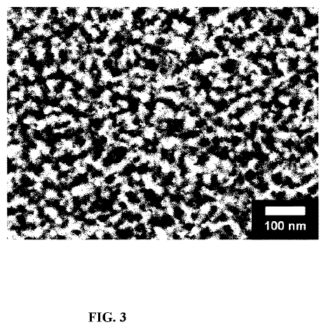

FIG. 3: Image recorded with the scanning electron microscope (view from above) of a produced porous W₂C film via carburizing reaction for 6 h at 700° C. on a silicon wafer as substrate.

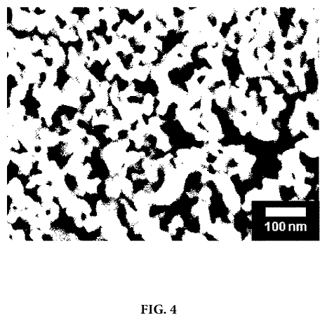

FIG. 4: Image recorded with the scanning electron microscope (view from above) of a porous W₂C/WC film produced in a carburizing reaction for 6 h at 750° C. on a silicon wafer as substrate.

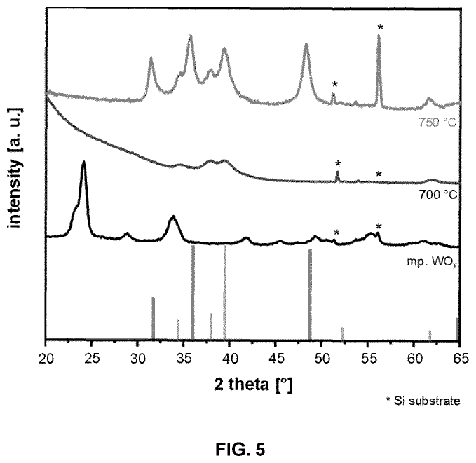

FIG. 5: X-ray diffractometric analysis under grazing incidence (GI-XRD) of the produced mesoporous WOₓ as well as the WCₓ layers via carburizing reaction for 6 h at 700° C. (dark gray) or 750° C. (light gray), starting with the mesoporous WOₓ (black) on a silicon wafer as substrate (reflexes with * indexed); reference pattern: WC (dark gray beam) as well as W₂C (light gray beam).

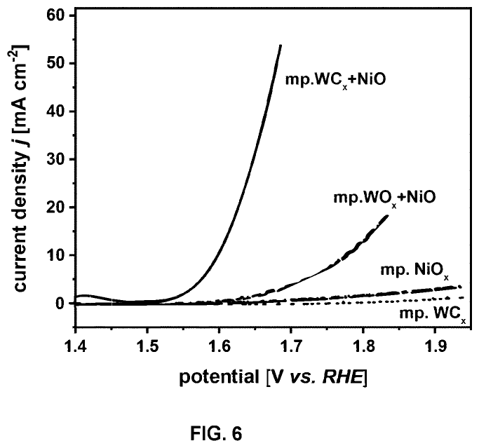

FIG. 6: Electro-catalytic measurements (50.CV) of the oxygen-forming reaction (OER, oxygen evolution reaction) in a rotating disc electrode at 0.1 M KOH and 25° C. in N₂ saturated electrolyte. Shown are measurements of produced mesoporous WCₓ layers via carburizing reaction for 6 h at 700° C. before (dotted graph), respectively after (continuous graph) the precipitation of catalytically active species, for example through NiO-ALD. All examined films were produced on a polished titanium sheet metal as substrate and were measured. As reference, mesoporous templated NiOₓ films (dash-dot) were produced and their OER activity examined. The higher catalytic activity of the coated mesoporous WCₓ substrate material is shown with the aid of the comparison to a similar amount of NiO-coated mesoporous WOₓ (dashed graph).

Example for the Production of a Mesoporous Tungsten Oxide Film with Subsequent Conversion to Tungsten Carbide Through Carburizing Reaction:

Chemicals: Tungsten (VI) chloride (>99% for the analysis) was obtained from Merck. Citric acid (>99.5% p.a. water-free) was obtained from Roth. The polymer template poly(ethylene oxide)-b-poly(butadiene)-b-poly(ethylene oxide) (18.700 g/mol PEO and 10,000 g/mol PB) was obtained from Polymer Service Merseburg GmbH. Ethanol (>99.9%, absolute) was obtained from VWR. All chemicals were used without further purification.

Film synthesis: Prior to the film precipitation, the silicon substrates were cleaned with ethanol and calcinated in air (2 h, 600° C.). The quartz substrates used were etched in an alkaline isopropyl solution for 30 minutes in the ultrasound bath. Template PEO₂₁₃-PB₁₈₄PEO₂₁₃ (55 mg 3.6 μmol), citric acid (384 mg. 2.0 mmol) and WCI₆ (397 mg. 1.0 mmol) were dissolved in 3.0 mL ethanol at 50° C. by stirring it. The solution took on a deep blue color. Adding in the complexing citric acid ensured a color change of the solution from deep green to deep blue. The films were produced via immersion coating of substrates with a return draw speed of 300 mm/min under a controlled atmosphere (25° C., 40% relative humidity). The films were then dried for at least 5 minutes. The films were treated in a tube furnace for 5 h at 500° C. in a nitrogen atmosphere, with subsequent cooling down to room temperature.

For the conversion to the metal carbide, the produced oxide layers were treated for 6 h at 700° C. in a ternary gas mixture of CH₄/H₂/Ar with a heat-up rate of 1K/min. The ratio of CH₄ to H₂ was adjusted to 1:6. The total gas flow was 150 mL/min. Following the cooling to 250° C., the films were passivated on the surface with the aid of a thin oxide layer. For this, a mixture of 1:1 N₂ to air was blown into the tube furnace.

Characterization: TEM recordings were made with a FEI Tecnai G 2 20 S TWIN at 200 kV acceleration voltage for films, which in part were scraped off the substrates and transferred to a copper net coated with carbon. The SEM recordings were recorded with a JEOL 7401F with an accelerating voltage of 10 kV and a working distance of 4 mm. The layer thicknesses were measured in the cross section. Image J, Version 1.39u (http://rsbeb.nih.gove/ij) was used to determine the pore diameter and the layer thickness. The Raman spectra were recorded with a LabRam HR 800 instrument (Horiba Jobin Yvon), coupled with a BX41 microscope (Olympus). The system is equipped with a HeNe Laser, having a wavelength of 633 nm and a 300 mm⁻¹ grid. XRD recordings were made with a Bruker D8 Advance (Cu-Ko-radiation) under grazing incidence diffraction angle of 1°. The reflexes were assigned using PDFMaintEx Library.

1. A method for producing a mesoporous metal carbide layer with defined nano-structuring, comprising the following steps:
a) making available a mesoporous metal oxide layer; and
b) bringing the mesoporous metal oxide layer in contact with a carbon source in a reducing atmosphere, at a temperature of at least 650° C., wherein the mesoporous metal carbide layer is generated through a carburizing reaction with a heat-up rate between 0.5-2 Kelvin per minute.

2. The method according to claim 1, wherein the
making available the mesoporous metal oxide layer comprises the following steps:
i) providing a metal precursor, a template, a first solvent and a complex former containing a carboxyl group, and dissolving the metal precursor, the template and the complex former in the first solvent, so that metal precursor complexes are formed;
ii) coating a substrate with the metal precursor complexes, so that a micelle-templated film layer forms on the substrate; and
iii) thermally treating the micelle-templated film layer under an inert gas atmosphere to form a templated mesoporous metal oxide.

3. The method according to claim 1, wherein step b) includes maintaining the reducing atmosphere during a time period ranging from 30 min to 10 hours.

4. The method according to claim 1, wherein the reducing atmosphere comprises a ternary gas mixture; including argon, hydrogen, ethanol, ethylene, CO, CO/CO₂ and methane on one hand or argon, hydrogen, ethanol ethylene, CO and methane on another hand, wherein a ratio of 5-7:1 exists between methane and hydrogen.

5. The method according to claim 2, wherein the metal precursor comprises either a metal and a transition metal or solely a transition metal so that the metal oxide is a transition metal oxide, and the metal carbide is a transition metal carbide.

6. The method according to claim 5, wherein the transition metal of the metal precursor is selected from a group consisting of scandium, titanium, vanadium, chromium, manganese, iron, cobalt, nickel, copper, zinc, yttrium, zirconium, niobium, molybdenum, technetium, ruthenium, rhodium, palladium, silver, lanthanum, cadmium, hafnium, tantalum, tungsten (wolfram), rhenium, osmium, iridium, platinum and gold.

7. The method according to claim 2, wherein the complex former comprises either mono-carbon, dicarbon or tri-carbon acids, amino acids and ethylene diamine tetra acetic acid or mono-carbon, dicarbon or tri-carbon acids and ethylene diamine tetra acetic.

8. The method according to claim 2, wherein the template forms either micelle and lamella structures of solely a lamella structure and the template is an amphiphile polymer.

9. The method according to claim 8, wherein the amphiphile polymer is an amphiphile block copolymer selected from a group consisting of polyethylene oxide-block-poly-butadiene-block-polyethylene oxide (PEO-PB-PEO), polyethylene oxide-block-polypropylene oxide-block-polyethylene oxide (PEO-PPO-PEO), polypropylene oxide-block-polyethylene oxide-block-polypropylene oxide (PPO-PEO-PPO), polyethylene oxide-block-polyisobutylene-block-polyethylene oxide (PEO-PIB-PEO), polyethylene-block-polyethylene oxide (PE-PEO), polyisobutylene-block-polyethylene oxide (PIB-PEO) and poly(ethylene-co-polybutylene)-block-poly(ethylene oxide) (PEB-PEO), polystyrene-block-poly(4-vinyl pyridine)(PS-P4VP) or mixtures thereof.

10. The method according to claim 2, wherein the step i) includes using for the first solvent at least one of C1-C4-alcohol, C₂-C₄-ester, C₂-C₄-ether, formamide, acetone nitril, acetone, tetrahydrofuran, benzyl acetate, toluene, dimethyl sulfoxide, dichloromethane, chloroform, methanol, ethanol, water or mixtures thereof.

11. The method according to claim 2, wherein the coating the substrate is performed using immersion coating, doctor-blading, drip coating, brushing on, pouring of the coating, spin coating, or spray coating.

12. The method according to claim 2, including conducting the steps of making available the mesoporous metal oxide at a temperature between 350° C. and 650° C. in the reducing gas mixture.

13. The method according to claim 2, wherein the substrate is selected from a group consisting of silicon, silicon dioxide, silicon carbide, boron carbide, steel, graphite, graphene, glass carbon, gold, silver, platinum, copper, nickel, aluminum, titanium, and alloys thereof and/or temperature-stable polymers or plastics or membranes or combinations of the alloys, temperature stable polymers, plastics and membranes.

14. A mesoporous metal carbide layer produced according to the method of claim 1.

15. The mesoporous metal carbide layer according to claim 14, wherein the mesoporous metal carbide layer comprises pores, wherein the pores are mesoporous, or macro-porous or a combination of mesoporous and microporous, and the pores are preferably-distributed uniformly.

16. The mesoporous metal carbide layer according to claim 15, wherein the metal carbide layer is coated with another pore-conformal layer.

17. (canceled)

18. The method according to claim 13, wherein the substrate is a wafer comprising a material selected from a group consisting of expanded metals and metal foams, solely metal or solely metal forms.

19. The metal carbide layer according to claim 16, wherein the pore-conformal layer is NiO.
